(19) United States
(12) Patent Application Publication
(10) Pub. No.: US 2025/0265821 A1
(43) Pub. Date: Aug. 21, 2025

(54) METHOD FOR TRAINING A MACHINE LEARNING MODEL TO ASCERTAIN BODY POSES AND POSITIONS OF A BODY HAVING MULTIPLE BODY PARTS

(71) Applicant: Robert Bosch GmbH, Stuttgart (DE)

(72) Inventors: Andrey Rudenko, Gerlingen (DE); Nisarga Nilavadi Chandregowda, Nürnberg (DE); Timm Linder, Boeblingen (DE)

(21) Appl. No.: 19/043,818

(22) Filed: Feb. 3, 2025

(30) Foreign Application Priority Data
Feb. 16, 2024 (DE) 10 2024 201 466.4

(51) Int. Cl. G06V 10/774; G06V 10/776; G06V 10/82; G06V 40/10; G06V 40/20

(52) U.S. Cl. CPC G06V 10/774; G06V 10/776; G06V 10/82; G06V 40/10; G06V 40/20

(57) ABSTRACT

A method for training a machine learning model to ascertain body poses and positions of a body having multiple body parts is provided. The method includes, for each training trajectory of a plurality of training trajectories, wherein each training trajectory indicates a position of each body part of the multiple body parts in a global coordinate system for each time of a given sequence of times: transforming the training trajectory into a transformed training trajectory; predicting, by means of the machine learning model, positions of the body parts at one or more times following the prediction start time; and ascertaining a loss by comparing the predicted positions with positions of the body parts indicated by the training trajectory in the training trajectory for the one or more times following the prediction start time.

### CROSS REFERENCE

The present application claims the benefit under 35 U.S.C. § 119 of German Patent Application No. DE 10 2024 201 466.4 filed on Feb. 16, 2024, which is expressly incorporated herein by reference in its entirety.

### FIELD

The present invention relates to methods for training a machine learning model to ascertain body poses and positions of a body having multiple body parts.

### BACKGROUND INFORMATION

The ability to predict human movements and recognize human activities is a crucial component for social robots and autonomous systems that operate in human spaces and have to interact with humans in domestic and industrial environments. In collaborative manufacturing environments, for example, robots accurately track and predict the future poses and activities of human workers in order to provide safe and efficient assistance in collaborative assembly tasks. Autonomous vehicles benefit from tracking the condition and attention of pedestrians in order to safely navigate urban streets. Automated systems, including mobile robots, manipulators and vehicles, therefore increasingly rely on motion prediction for safe navigation, improved human-robot collaboration, person tracking, event observation, and simulation purposes.

Predicting the movement of humans (or animals) involves predicting a motion trajectory and predicting a pose. Motion trajectory prediction focuses on the coarse prediction of the motion path of dynamic entities. Pose prediction (or whole-body pose prediction), on the other hand, deals with the fine-grained prediction of the human 3D skeletal joints in relation to a fixed reference point of the body, usually the pelvis or the torso.

For both of these, accurate and efficient methods (in terms of memory requirements, (training) data efficiency and computational effort) are desirable.

### SUMMARY

According to various example embodiments of the present invention, a method for training a machine learning model to ascertain body poses and positions of a body having multiple body parts is provided, comprising:
for each training trajectory of a plurality of training trajectories, wherein each training trajectory indicates a position of each body part of the multiple body parts in a global coordinate system for each time of a given sequence of times,
   transforming the training trajectory into a transformed training trajectory such that, for a time, defined as the prediction start time, of the sequence of times, the position of a specified reference body part corresponds to a specified point in the global coordinate system and the direction of movement of the reference body part corresponds to a specified direction in the global coordinate system;
   predicting, by means of the machine learning model, positions of the body parts at one or more times following the prediction start time, by supplying the positions of the body parts indicated by the transformed training trajectory up to the prediction start time to the machine learning model; and
   ascertaining a loss by comparing the predicted positions with positions of the body parts indicated by the training trajectory in the training trajectory for the one or more times following the prediction start time; and
adapting the machine learning model to reduce an overall loss that includes the ascertained losses.

The method of the present invention described above allows for joint prediction of motion trajectory and pose with balanced accuracy for motion trajectory and pose prediction in scenarios that are most important for a mobile robot. Furthermore, it allows for prediction with high computational efficiency, which makes its use in real time possible, in particular for human-oriented motion planning for mobile robots, e.g., autonomous vehicles and intralogistics robots.

The prediction can be used as part of a pipeline for (in particular mobile) autonomous systems and/or also for stationary manipulators and co-production robots: detection, tracking, prediction, planning, control. An autonomous system navigating in shared environments is thus able to recognize and track other dynamic agents, plan its own navigation trajectory, and execute it through a series of control actions. The prediction module, for example, provides information for tracking people and thus for trajectory planning and control actions.

According to various example embodiments of the present invention, a graph-attention-based transformer model (i.e., a neural network with transformer architecture) with input data transformation is provided, which allows for the prediction of motion trajectory and poses in the form of 3D positions of a set of body parts in a global coordinate system. This allows for real-time predictions for robotic applications that require immediate responses.

The method of the present invention allows for the prediction of posture dynamics and motion trajectories for different locomotion styles, including running, accelerating, decelerating, and turning, i.e., the types of movements that are important for socially acceptable robot navigation.

Various exemplary embodiments of the present invention are specified below.

Exemplary embodiment 1 is a method as described above.

Exemplary embodiment 2 is the method according to exemplary embodiment 1, wherein the machine learning model has a graph attention network, by means of which the positions of the body parts indicated by the transformed training trajectory up to the prediction start time are processed by representing, for each of the times up to the prediction start time, a corresponding pose as a graph in that each of the body parts is assigned a node with the corresponding indicated position as node features and nodes assigned to connected body parts (e.g., according to a skeleton model) are connected by an edge, and processing the graphs by means of the graph attention network.

In this way, associations between body parts (e.g., connections by bones) are effectively taken into account.

Exemplary embodiment 3 is the method according to exemplary embodiment 1 or 2, wherein the machine learning model has a transformer architecture.

A transformer allows for temporal sequences to be taken into account effectively, as is required when predicting poses based on a sequence of previous poses. The use of attention mechanisms also allows taking into account semantic contexts of different poses (such as looking to the right and left before crossing a street: looking around can indicate that the person in question will move forward thereafter).

Exemplary embodiment 4 is the method according to one of exemplary embodiments 1 to 3, comprising ascertaining spatial-temporal encodings of the positions indicated by the transformed training trajectory up to the prediction start time and supplying the spatial-temporal encodings, together with the positions of the body parts indicated by the transformed training trajectory up to the prediction start time, to the machine learning model.

The combination of spatial position encoding (as typically provided by the use of a transformer, e.g., for processing text) with temporal encoding allows the machine learning model to take into account the pose changes in the input sequence, which improves the prediction.

Exemplary embodiment 5 is the method according to one of exemplary embodiments 1 to 4, wherein the loss contains a first loss component, which, for each of the one or more times following the prediction start time and for each of the body parts, contains as a loss contribution the difference between the predicted position of the body part and the position of the body part indicated by the training trajectory or transformed training trajectory, and/or wherein the one or more times following the prediction start time have one or more pairs of consecutive times and the loss contains a second loss component, which, for each of the one or more pairs and for each of the body parts, contains as a loss contribution the difference between the difference in the positions predicted for the times of the pair and the difference in the positions of the body part indicated by the training trajectory or transformed training trajectory for the times of the pair.

In particular, a combined loss, which contains both a pose loss (first loss component) and a trajectory loss (second loss component), can be used so that the machine learning model predicts both good absolute and relative (i.e., consistent) trajectories.

Exemplary embodiment 6 is a method for predicting one or more body poses and one or more positions of a body having multiple body parts, comprising:
training a machine learning model according to one of exemplary embodiments 1 to 5;
detecting a trajectory of the body, which indicates, for each detection time of a sequence of detection times, a position of each body part of the multiple body parts in the global coordinate system;
transforming the detected trajectory into a transformed detected trajectory such that for the last of the detection times, the position of the specified reference body part corresponds to the specified point in the global coordinate system and the direction of movement of the reference body part corresponds to a specified direction in the global coordinate system; and
predicting, by means of the machine learning model, positions of the body parts by supplying the positions of the body parts indicated by the transformed detected trajectory to the machine learning model.

Exemplary embodiment 7 is a method according to exemplary embodiment 6, further comprising controlling a robotic device depending on the predicted positions of the body parts (i.e., the method in this case is a method for controlling a robotic device).

Exemplary embodiment 8 is a data processing system (in particular a control unit) that is configured to carry out a method according to one of exemplary embodiments 1 to 7.

Exemplary embodiment 9 is a computer program comprising commands which, when executed by a processor, cause the processor to carry out a method according to one of exemplary embodiments 1 to 7.

Exemplary embodiment 10 is a computer-readable medium storing commands which, when executed by a processor, cause the processor to carry out a method according to one of exemplary embodiments 1 to 7.

In the figures, similar reference signs generally refer to the same parts throughout the various views. The figures are not necessarily true to scale, with emphasis instead generally being placed on the representation of the principles of the present invention. In the following description, various aspects are described with reference to the figures.

### BRIEF DESCRIPTION OF THE DRAWINGS

FIG. 1 shows a vehicle, according to an example embodiment of the present invention.

FIG. 2 illustrates a pose prediction and a motion trajectory prediction, according to an example embodiment of the present invention.

FIG. 3 illustrates an input data transformation according to an example embodiment of the present invention.

FIG. 4 shows a machine learning model for pose trajectory prediction according to an example embodiment of the present invention.

FIG. 5 shows a flow chart that represents a method for training a machine learning model to ascertain body poses and positions of a body having multiple body parts, according to an example embodiment of the present invention.

### DETAILED DESCRIPTION OF EXAMPLE EMBODIMENTS

The following detailed description relates to the figures, which show, by way of explanation, specific details and aspects of this disclosure in which the present invention can be executed. Other aspects may be used, and structural, logical, and electrical changes may be performed without departing from the scope of protection of the present invention. The various aspects of this disclosure are not necessarily mutually exclusive, since some aspects of this disclosure may be combined with one or more other aspects of this disclosure to form new aspects.

Various examples are described in more detail below.

### DETAILED DESCRIPTION OF EXAMPLE EMBODIMENTS

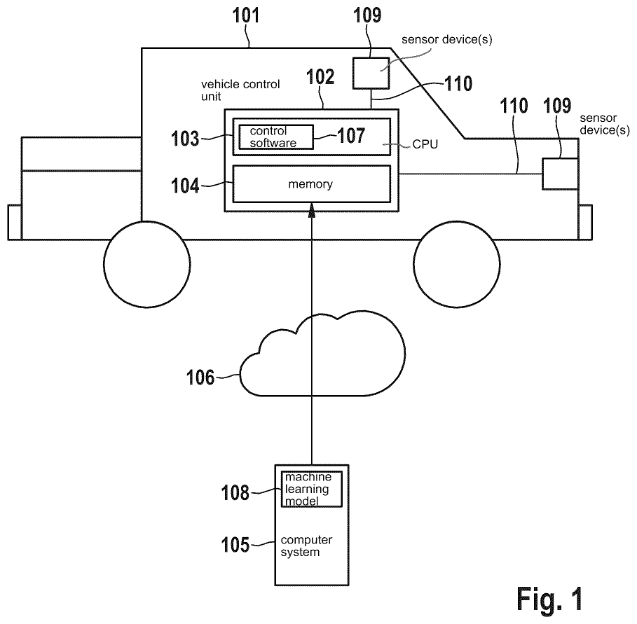

FIG. 1 shows a vehicle 101.

In the example of FIG. 1, a vehicle 101, for example a passenger car or truck, is provided with a vehicle control unit (also referred to as an electronic control unit (ECU), e.g., a control device) 102.

The vehicle control unit 102 comprises data processing components, for example a processor (for example, a CPU (central processing unit)) 103 and a memory 104 for storing control software 107 according to which the vehicle control unit 102 operates, and data that are processed by the processor 103. The processor 103 executes the control software 107.

For example, the stored control software (computer program) comprises instructions which, when executed by the processor, cause the processor 103 to perform driver assistance functions (i.e., the function of an ADAS (advanced driver assistance system)) or even to control the vehicle autonomously (AD (autonomous driving)).

The control software 107 is, for example, transmitted to the vehicle 101 from a computer system 105, for example via a communication network 106 (or by means of a storage medium such as a memory card). This can also take place in operation (or at least when the vehicle 101 is with the user) since the control software 107 is updated over time to new versions, for example.

The control software 107 ascertains control actions for the vehicle (such as steering actions, braking actions, etc.) from input data that are available to it and that contain information about the environment or from which it derives information about the environment (for example by detecting other road users, e.g., other vehicles, pedestrians, bicyclists, etc.). These input data are, for example, sensor data from one or more sensor devices 109, for example from a camera of the vehicle 101, which are connected to the vehicle control unit 102 via a communication system 110 (e.g., a vehicle bus system such as CAN (controller area network)).

The control software 107 can be trained at least partially, for example by means of machine learning (ML), i.e., the control software 107 implements, for example, a machine learning model 108 (e.g., a neural network (NN)) that is trained on the basis of training data, in this example from the computer system 105. The computer system 105 thus implements an ML training algorithm for training one (or more) ML model(s) 108.

For example, the ML model 108 (e.g., a neural network) is an ML model for predicting the behavior of other road users, such as pedestrians. This includes, for example, the prediction of motion trajectories (e.g., a sequence of 2D positions for a walking person) and the prediction of poses (e.g., the prediction of the positions of the whole-body joints in relation to a specified “central” body part or joint, e.g., the pelvis or hip). The latter is of interest because, for example, the direction in which a pedestrian's head is turned provides information about the direction in which they wish to walk. For example, the typical looking left and right can be an indication that a pedestrian wishes to cross a street.

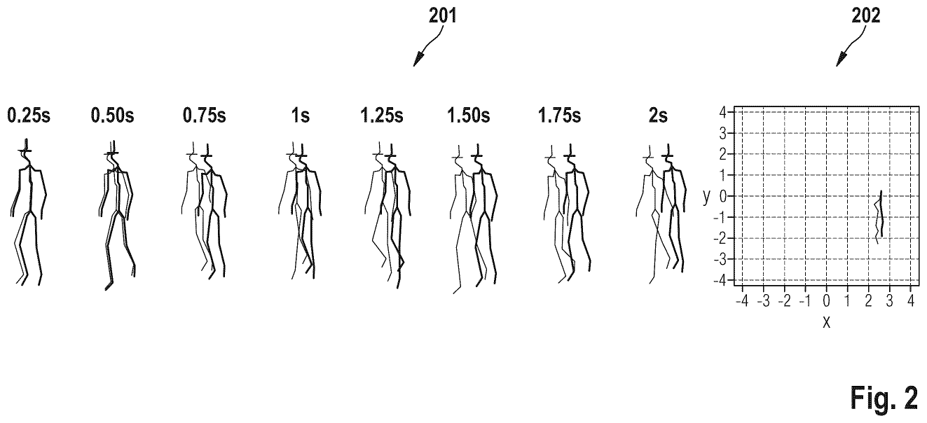

For other use cases as well, e.g., for other mobile robots, both motion trajectory prediction and pose prediction are of interest. For example, in collaborative manufacturing environments, it is desirable for robots to be able to accurately predict the future positions and activities (e.g., arm movements) of human workers in order to provide safe and efficient assistance in collaborative assembly tasks. FIG. 2 illustrates a prediction of poses 201 and, in a diagram 202, a motion trajectory prediction (ground truth and prediction in each case, starting from the prediction start time 0 s).

Motion trajectory prediction and pose prediction can be treated as separate problems, but, in this case, two machine learning models are accordingly required. For example, motion trajectories are expressed as displacements [dx,dy](or velocities) of a 2D position above the ground plane. This encoding of the 2D motion trajectory provides a similar representation of different motion trajectories independently of their absolute (X, Y) coordinates, allowing for generalization by the machine learning model for motion trajectory prediction. For pose prediction, in addition to the 2D position coordinates, 3D joint coordinates (or body part coordinates) relative to the 2D position are encoded.

Decoupled (separate) pose and motion trajectory prediction modules can also be merged at the end of a prediction pipeline in order to achieve simultaneous prediction of pose and motion trajectories. However, this also leads to a large (and thus memory-intensive) and computationally intensive machine learning model (e.g., neural network), which performs suboptimally due to the separate treatment of locomotion dynamics and body movement dynamics, which are in reality tightly coupled.

Therefore, according to various embodiments, a coupled approach (for a joint prediction of motion trajectory and pose) is provided, in which training is carried out using an (input data) transformation in global coordinates, i.e., the entire sequence of the coordinates of the joints of the 3D skeleton is expressed in relation to a single reference point (e.g., the position of the pelvic joint at the “prediction time,” i.e., at the time of the last state of the input state sequence on the basis of which the prediction is made).

Joint prediction can approximately halve the number of parameters of the machine learning model compared to an approach in which, as described above, there are two prediction modules whose results are merged, and a faster inference time and more accurate prediction of the motion trajectory (which is the critical part of the problem in the case of a mobile robot or autonomous vehicle) can be achieved.

According to various embodiments, the coupled prediction of the motion trajectory and pose (e.g., of a walking person) is performed using a machine learning model (corresponding, for example, to machine learning model 108) that has a transformer architecture. Here, 3D body part positions (in a global coordinate system), which are derived, for example, from a 3D position estimation pipeline for humans, are used directly. Thus, the position of a reference body part (e.g., the hip) is not treated separately from the positions of other body parts; rather, all body part positions are used together as input. The input for the machine learning model is thus a (pose) trajectory in the form of an (input) sequence of states (or “frames”) for a sequence of times up to the prediction start time, wherein each state contains the 3D position for a specified set of body parts (e.g., positions of joints, or limb center positions, etc.). The term “pose trajectory” (hereinafter also simply “trajectory”) is used here for a sequence of poses. In contrast, “motion trajectory” refers only to the sequence of positions of the body in question (i.e., for example, the position of a central body part such as the hip) but not the positions of multiple body parts in the global coordinate system (i.e., reference frame). According to various embodiments, this input (i.e., a pose trajectory) is transformed via an (input data) transformation in order to couple pose and trajectory prediction streams in a unified architecture, thus simplifying the machine learning model for simultaneous pose and trajectory prediction as a coupled task. For training trajectories that, in addition to the input sequence of states (i.e., the past trajectory), also contain states for one or more further times (after the prediction start time, i.e., a future trajectory) as ground truth, these states are also transformed for training, or the prediction of the machine learning model is back-transformed before it is compared with the ground truth for the loss calculation.

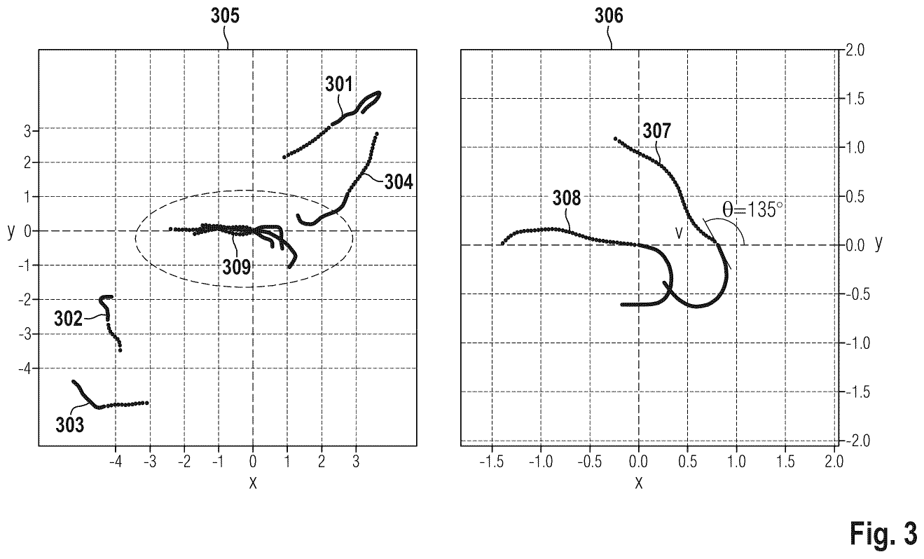

FIG. 3 illustrates the input data transformation according to an embodiment for four training trajectories 301, 302, 303, 304.

The four training trajectories 301-304 are shown in a first diagram 305 in global coordinates and, for simplicity, as a sequence of 2D positions. The dotted part is the past trajectory, and the solid part is the future trajectory (which is also shown here for illustration but is omitted for the inference).

The transformation includes aligning the training trajectories 301-304 with the origin (X=0, Y=0) and the positive X-axis direction, as shown in more detail in the second diagram 306 for a trajectory: The trajectory 307 is transformed into a transformed trajectory 308 such that the prediction start time is placed at the origin and the direction of movement at the prediction start time corresponds to the X-axis direction.

The input data transformation thus serves to convert input trajectories (in particular training trajectories) into a common reference frame (in particular for learning) by means of rotation and translation. The result is transformed input trajectories 309. This allows for generalization beyond the different training trajectories in global coordinates and training with absolute 3D coordinates without separation into separate pose and trajectory prediction data streams.

In addition to the input data transformation, a graph attention network (GAT) is used according to various embodiments to generate graph embeddings that capture the spatial skeletal structure and thus inform the machine learning model about the skeletal hierarchy and the relative dependencies between individual joints. For this purpose, a GAT encoder is applied to the states of the input trajectory using the adjacency matrix of the skeleton, resulting in a more accurate and realistic prediction of the body dynamics.

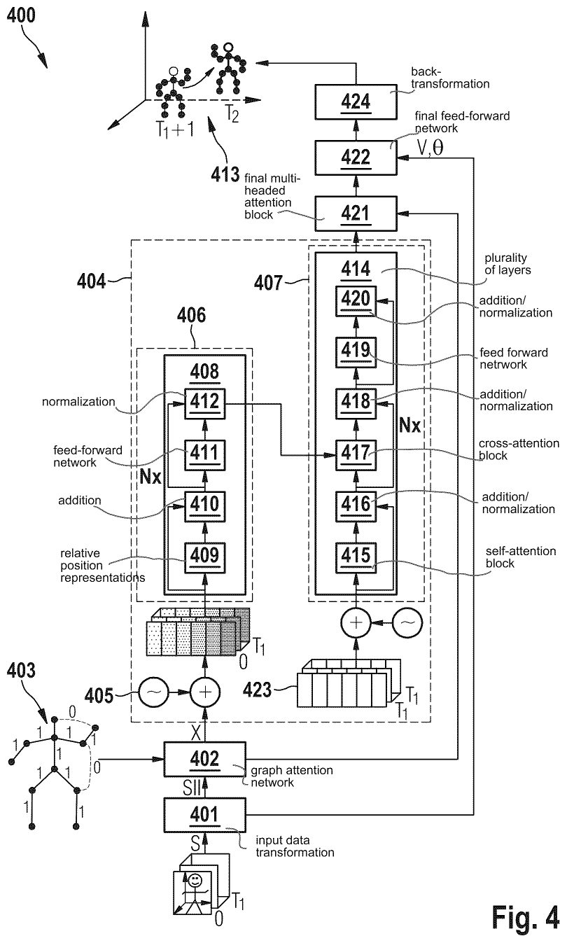

FIG. 4 shows a machine learning model 400 for pose trajectory prediction (i.e., joint prediction of motion trajectory and pose) according to an embodiment.

In the following, P(t)∈ [symbol] ^{3N} denotes the body pose (e.g., human pose) at time t, which includes N three-dimensional body part positions (e.g., positions of joints):

P(t)={j₁(t), j₂(t), . . . , j_{N}(t)}, where each jᵢ(t)∈ [symbol] ³ represents the three spatial coordinates (x, y, z) of the i-th body part positions (e.g., the i-th joint) in the coordinate system of the robot at time t. An input trajectory (input sequence of states) is a sequence of poses from time 0 to the prediction start time T1: [symbol] ∈ [symbol] ^{T}^{₁}^{×3N}, all of which relate to the same person:

$$S = \{ P ( 0 ) , P ( 1 ) , … , P ( {T}_{1} ) \} \qquad ( 1 )$$

The goal of the machine learning model 400 is to predict a sequence of poses from time T₁+1 until time T₁+T₂ with global translation Sₒᵤₜ∈ [symbol] ^{(T}^{₂}^{-T}^{₁}^{)×3N}:

$${S}_{out} = \{ P ( {T}_{1} + 1 ) , … , P ( {T}_{1} + {T}_{2} ) \} ⋃ \{ 𝒯 ( {T}_{1} + 1 ) , … , 𝒯 ( {T}_{1} + {T}_{2} ) \} \qquad ( 2 )$$

As described above, for an input trajectory [symbol] ∈ [symbol] ^{T}^{₁}^{×3N}, an input data transformation 401 takes place first.

This input data transformation is used to normalize the input trajectories to a common reference frame in order to generalize and predict human motion in global coordinates across different directions of movement. As described with reference to FIG. 3, global invariance is achieved by ensuring that all predictions start from a consistent origin by performing a translation using the vector v, which is derived as the negative counterpart of the position of a reference body part (with index r (for “root”), e.g., hip) of the last state of the input sequence, i.e., v=−jᵥ(T₁). The translation with the vector v is applied to each state of the input sequence [symbol] , resulting in a sequence [symbol] ′.

For each state (frame) of [symbol] , the associated shifted pose in [symbol] ′ is given by:

$${P}^{′} ( t ) = P ( t ) + v ∀ t ∈ [ 0 , T ] \qquad ( 3 )$$

This shift anchors the human pose of the last state of the input sequence to the origin, providing a uniform starting point for the subsequent motion predictions.

Furthermore, orientation invariance is established by the input data transformation 401 by canonically aligning the direction of movement with the positive x-axis. For this purpose, a rotation angle θ is calculated based on the direction of movement of the input trajectory (at the prediction start time) and the positive x-axis. This angle is calculated as the arctangent of the ratio of the differences of the y- and x-coordinates of the position of the reference body part of the last state of the input sequence T1 and the position of the reference body part at a previous time (T1−w), where w (for “window”) is a specified time interval:

$$θ = arc tan 2 ( Δ y , Δ x ) \{ \begin{matrix}Δ x = {{j}_{r} ( {T}_{1} )}_{x} - {{j}_{root} ( {T}_{1} - w )}_{x} \\ Δ y = {{j}_{r} ( {T}_{1} )}_{y} - {{j}_{root} ( {T}_{1} - w )}_{y}\end{matrix} \qquad ( 4 )$$

Finally, a corresponding rotation matrix for a rotation about the z-axis is applied to the shifted sequence S′, resulting in the rotated sequence S″:

$${P}^{″} ( t ) = [ \begin{matrix}cos ( - θ ) & - sin ( - θ ) & 0 \\ sin ( - θ ) & cos ( - θ ) & 0 \\ 0 & 0 & 1\end{matrix} ] \cdot {P}^{′} ( t ) ∀ t ∈ [ 0 , T ] \qquad ( 5 )$$

The pose sequence S″ is the result of the input data transformation 401.

A GAT (graph attention network) 402 now generates, as briefly described above, spatial graph embeddings from the pose sequence S″. Any human pose can be represented as a graph 403, where each joint in the pose corresponds to a node and the connections between them (bones or body parts) are the edges. The input for the GAT 402 is a modified version of the pose sequence S″: Each joint (or generally each body part) is a node in the graph 403 with three spatial features jᵢ(t)∈ [symbol] ³ (given by the position of the body part). The edges E are determined based on the kinematic chain of the body skeleton used, which may vary depending on the dataset. From this kinematic chain, an adjacency matrix A is derived so that Aᵢⱼ=1 if there is a connection between the joints jᵢ(t) and jⱼ(t), and otherwise 0. The GAT 402 calculates attention scores e between pairs of joints, which capture the importance of one joint compared to another:

$${e}_{ij} = LeakyReLU ( {a}^{T} [ {Wj}_{i} ( t ) ‖ {W}_{{j}_{j}} ( t ) ] ) \qquad ( 6 )$$

where ∥ denotes the concatenation and a and W are learnable parameters (vector or matrix). Using normalized attention coefficients, the common features are updated by aggregating the information from adjacent joints, resulting in the common embeddings.

The GAT 402 thus generates a new set of node features X∈ [symbol] ^{T}^{₁}^{×N×J}^{_{dim}} as output and thus generates common embeddings for all poses of the input sequence.

Subsequently, the common embeddings of the input sequence are flattened in order to create an overall pose embedding of the input sequence in [symbol] ^{T}^{₁}^{×(N×J}^{_{dim}}⁾. The GAT 402 is used to facilitate attention mechanisms between the body parts within a frame and to effectively capture the spatial relationships. The output of the GAT 402 is supplied to a transformer (network) 404. The transformer is designed to recognize and learn the temporal relationships between poses in order to ensure comprehensive understanding of the spatial and temporal dynamics in the data. In addition to the embeddings generated by the GAT 402, a further (spatial-temporal) position encoding 405 is used to capture human dynamics in detail.

For this purpose, sinusoidal spatial position encodings, which are specifically tailored to distinguish between the different joints in each image, are generated. For each joint, this approach generates a position encoding of dimension J_{dim}, which takes into account all N joints. In addition, temporal encodings are generated in order to detect the temporal progression of sequences. These temporal encodings have the dimensions J_{dim}×N, take all frames into account and illustrate the sequential dynamics from one frame to the next. The spatial position encodings are flattened and then merged with the temporal encodings in order to obtain a unified 2D position encoding 405.

The transformer 404 has a classic transformer architecture with an encoder 406 and a decoder 407. The encoder 406 receives the output of the GAT 205 together with the (spatial-temporal) position encoding 405 and processes it through L layers 408. Each layer contains a self-attention block (masked single-headed self-attention with RPP (relative position representations)) 409 and a feed-forward network 411 (each followed by a corresponding addition and normalization operation 410, 412). The layers 408 process the input to form a sequence of elements in a latent space Z=[z₁, z₂, . . . , z_{T}].

The decoder 407 then uses this sequence of elements of the latent space to generate an initial position sequence 413. The decoder contains a plurality of layers 414, each with a self-attention block (masked single-headed self-attention with RPP) 415, a multi-headed cross-attention block 417 and a feed-forward network 419 (again each followed by a corresponding addition and normalization operation 416, 418, 420) and, after these, a final multi-headed attention block 421, followed by a final feed-forward network 422.

In order to ensure that a predicted pose is influenced only by previous poses (i.e., up to T₁) and does not depend on future poses, “casual masked self-attention” is used for both the encoder 406 and the decoder 407. The core principle of masked self-attention is that during the calculation of attention weights, certain weights are set to an extremely negative value, e.g., 10⁻⁹, by using a mask. This mask is designed such that for a given sequence position, all future positions in the sequence are marked as irrelevant. When the softmax function is subsequently applied to these weights during the attention mechanism, the values corresponding to the masked positions become negligible.

In self-attention with relative position representation, the attention values for a given sequence position are weighted more strongly in the direction of the immediately adjacent poses. This is advantageous for sequences with human poses, where not only the order of the poses is important, but also the relative transition between the images. This consideration of relative distances can lead to a better understanding of human movement sequences.

The decoder's self-attention queries are initialized with x(T1) (as query 423), that is, with the last input state, which is repeated multiple times corresponding to the number of desired output poses.

After the decoding phase by the layers 414, the final multi-headed attention block 421 executes a multi-head attention mechanism, also called end attention, using the output of the layers 414 as a query and taking into account the output of the GAT 402, which is used as both a key and a value.

Subsequently, the embeddings output by the multi-headed attention block 421 are propagated through the linear layers of the final feed-forward network 422 and, using v and 0, are converted back into the original motion orientation and the global coordinate space by means of a back-transformation 424, which results in the predicted 3D poses and the associated trajectories, i.e., the initial position sequence:

$$\hat{Y} = \{ {\hat{y}}_{{T}_{1} + 1} , {\hat{y}}_{{T}_{1} + 2} , … , {\hat{y}}_{{T}_{1} + {T}_{2}} \}$$

The machine learning model 400 can be trained with a combined pose and trajectory loss. Since each pose has a dimensionality of 3N (where N is the number of body parts), the predicted pose sequence is a sequence of vectors ŷT₁+1, ŷT₁+2, . . . , ŷT₁+T₂ and the ground truth position sequence is a sequence of vectors yT₁+1, yT₁+2, . . . , yT₁+T₂. If L1 denotes the pose loss and L2 the trajectory loss, the combined loss (for a training trajectory) is L=L1+L2 with

$${L}_{1} = \frac{1}{3 N ( {T}_{2} - {T}_{1} - 1 )} {\sum }_{t = {T}_{1} + 1}^{{T}_{1} + {T}_{2}} {‖ {\hat{y}}_{t} - {y}_{t} ‖}^{2} \qquad ( 7 )$$

$$and$$

$${L}_{2} = \frac{1}{3 N ( {T}_{2} - {T}_{1} )} {\sum }_{t = {T}_{1} + 1}^{{T}_{1} + {T}_{2} - 1} {‖ ( {\hat{y}}_{t + 1} - {\hat{y}}_{t} ) - ( {y}_{t + 1} - {y}_{t} ) ‖}^{2} \qquad ( 8 )$$

Over a batch of training trajectories, this combined loss can be aggregated (or averaged) to obtain an overall (batch) loss, and the parameters (weights, etc.) of the machine learning model can be adapted in the direction of decreasing overall loss.

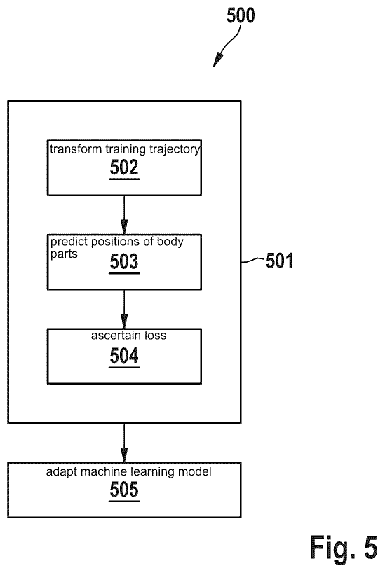

In summary, according to various embodiments, a method is provided as shown in FIG. 5.

FIG. 5 shows a flow chart 500 illustrating a method for training a machine learning model to ascertain body poses and positions of a body with multiple body parts (e.g., a person or an animal but also, e.g., a mechanical system with one or more degrees of freedom with respect to the relative position of components) according to an embodiment.

In 501, for each training trajectory of a plurality of training trajectories, wherein each training trajectory indicates a position of each body part (e.g., joint or connecting element between two joints) of the multiple body parts in a global coordinate system for each time of a corresponding sequence of times,
in 502, the training trajectory is transformed into a transformed training trajectory such that, for a time, defined as the prediction start time, of the sequence of times, the position of a specified reference body part corresponds to a specified point in the global coordinate system (e.g., origin) and the direction of movement of the reference body part corresponds to a specified direction in the global coordinate system;
in 503, positions of the body parts at one or more times following the prediction start time are predicted (i.e., ascertained) by means of the machine learning model by supplying the positions of the body parts indicated by the transformed training trajectory up to the prediction start time to the machine learning model;
in 504, a (single) loss is ascertained by comparing the predicted positions with positions of the body parts indicated by the training trajectory in the training trajectory for the one or more times following the prediction start time.

In 505, the machine learning model is adapted to reduce an overall loss that includes the ascertained losses (i.e., the (trainable) parameters (e.g., weights) are adjusted in the direction of a decreasing overall loss that includes the individual losses).

The method of FIG. 5 can be carried out by one or more computers with one or more data processing units. The term “data processing unit” may be understood as any type of entity that allows for processing of data or signals. The data or signals can be treated, for example, according to at least one (i.e., one or more than one) special function which is performed by the data processing unit. A data processing unit can comprise or be formed from an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA) or any combination thereof. Any other way of implementing the particular functions described in more detail herein may also be understood as a data processing unit or logic circuit assembly. One or more of the method steps described in detail here can be executed (e.g., implemented) by a data processing unit by one or more special functions that are performed by the data processing unit.

The method is therefore in particular computer-implemented according to various embodiments.

After training, the machine learning model can be used to generate a control signal for a robotic device by supplying it with sensor data relating to its environment or (past) pose trajectories (e.g., of people) derived therefrom, and thus generating predictions for one or more poses (in the global coordinate system). The term “robotic device” may be understood to refer to any technical system (comprising a mechanical part whose movement is controlled), such as a computer-controlled machine, a vehicle, a household appliance, a power tool, a manufacturing machine, a personal assistant or an access control system.

Various embodiments can receive time series of sensor data from various sensors, such as video, radar, lidar, ultrasound, motion, heat imaging, etc., and can use them to ascertain past poses.

What is claimed is:

1. A method for training a machine learning model to ascertain body poses and positions of a body having multiple body parts, comprising the following steps:
for each training trajectory of a plurality of training trajectories, wherein each training trajectory indicates a position of each body part of the multiple body parts in a global coordinate system for each time of a given sequence of times:
transforming the training trajectory into a transformed training trajectory such that, for a time, defined as a prediction start time, of the sequence of times, the position of a specified reference body part corresponds to a specified point in the global coordinate system and a direction of movement of the reference body part corresponds to a specified direction in the global coordinate system,
predicting, using the machine learning model, positions of the body parts at one or more times following the prediction start time, by supplying the positions of the body parts indicated by the transformed training trajectory up to the prediction start time to the machine learning model, and
ascertaining a loss by comparing the predicted positions with positions of the body parts indicated by the training trajectory in the training trajectory for the one or more times following the prediction start time; and
adapting the machine learning model to reduce an overall loss that includes the ascertained losses.

2. The method according to claim 1, wherein the machine learning model has a graph attention network, using the positions of the body parts indicated by the transformed training trajectory up to the prediction start time are processed by representing, for each of times up to the prediction start time, a corresponding pose as a graph in that each of the body parts is assigned a node with a corresponding indicated position as node features and nodes assigned to connected body parts are connected by an edge, and processing the graphs using the graph attention network.

3. The method according to claim 1, wherein the machine learning model has a transformer architecture.

4. The method according to claim 1, comprising ascertaining spatial-temporal encodings of the positions indicated by the transformed training trajectory up to the prediction start time and supplying the spatial-temporal encodings, together with the positions of the body parts indicated by the transformed training trajectory up to the prediction start time, to the machine learning model.

5. The method according to claim 1, wherein:
the loss contains a first loss component, which, for each of the one or more times following the prediction start time and for each of the body parts, contains as a loss contribution a difference between the predicted position of the body part and the position of the body part indicated by the training trajectory or transformed training trajectory, and/or
the one or more times following the prediction start time have one or more pairs of consecutive times and the loss contains a second loss component, which, for each of the one or more pairs and for each of the body parts, contains as a loss contribution the difference between the difference in the positions predicted for the times of the pair and the difference in the positions of the body part indicated by the training trajectory or transformed training trajectory for the times of the pair.

6. A method for predicting one or more body poses and one or more positions of a body having multiple body parts, comprising:
training a machine learning model by:
for each training trajectory of a plurality of training trajectories, wherein each training trajectory indicates a position of each body part of the multiple body parts in a global coordinate system for each time of a given sequence of times:
transforming the training trajectory into a transformed training trajectory such that, for a time, defined as a prediction start time, of the sequence of times, the position of a specified reference body part corresponds to a specified point in the global coordinate system and a direction of movement of the reference body part corresponds to a specified direction in the global coordinate system,
predicting, using the machine learning model, positions of the body parts at one or more times following the prediction start time, by supplying the positions of the body parts indicated by the transformed training trajectory up to the prediction start time to the machine learning model, and
ascertaining a loss by comparing the predicted positions with positions of the body parts indicated by the training trajectory in the training trajectory for the one or more times following the prediction start time; and
adapting the machine learning model to reduce an overall loss that includes the ascertained losses;
detecting a trajectory of the body, which indicates, for each detection time of a sequence of detection times, a position of each reference body part of the multiple body parts in the global coordinate system;
transforming the detected trajectory into a transformed detected trajectory such that for a last of the detection times, a position of the body part corresponds to a specified point in the global coordinate system and a direction of movement of the reference body part corresponds to a specified direction in the global coordinate system; and
predicting, using the machine learning model, positions of the body parts by supplying the positions of the body parts indicated by the transformed detected trajectory to the machine learning model.

7. The method according to claim 6, further comprising controlling a robotic device depending on the predicted positions of the body parts.

8. A data processing system configured to for training a machine learning model to ascertain body poses and positions of a body having multiple body parts, comprising the following steps:
for each training trajectory of a plurality of training trajectories, wherein each training trajectory indicates a position of each body part of the multiple body parts in a global coordinate system for each time of a given sequence of times:
transforming the training trajectory into a transformed training trajectory such that, for a time, defined as a prediction start time, of the sequence of times, the position of a specified reference body part corresponds to a specified point in the global coordinate system and a direction of movement of the specified reference body part corresponds to a specified direction in the global coordinate system,
predicting, using the machine learning model, positions of the body parts at one or more times following the prediction start time, by supplying the positions of the body parts indicated by the transformed training trajectory up to the prediction start time to the machine learning model, and
ascertaining a loss by comparing the predicted positions with positions of the body parts indicated by the training trajectory in the training trajectory for the one or more times following the prediction start time; and
adapting the machine learning model to reduce an overall loss that includes the ascertained losses.

9. A non-transitory computer-readable medium on which is stored commands for training a machine learning model to ascertain body poses and positions of a body having multiple body parts, comprising the following steps:
for each training trajectory of a plurality of training trajectories, wherein each training trajectory indicates a position of each body part of the multiple body parts in a global coordinate system for each time of a given sequence of times:
transforming the training trajectory into a transformed training trajectory such that, for a time, defined as a prediction start time, of the sequence of times, the position of a specified reference body part corresponds to a specified point in the global coordinate system and a direction of movement of the specified reference body part corresponds to a specified direction in the global coordinate system,
predicting, using the machine learning model, positions of the body parts at one or more times following the prediction start time, by supplying the positions of the body parts indicated by the transformed training trajectory up to the prediction start time to the machine learning model, and
ascertaining a loss by comparing the predicted positions with positions of the body parts indicated by the training trajectory in the training trajectory for the one or more times following the prediction start time; and
adapting the machine learning model to reduce an overall loss that includes the ascertained losses.
